(19) United States
(12) Patent Application Publication
(10) Pub. No.: US 2010/0100314 A1
(43) Pub. Date: Apr. 22, 2010

(54) INTERACTIVE POSITIONING APPARATUS AND INTERACTIVE METHOD THEREOF

(76) Inventor: Hung-Yao YEH, Taipei County (TW)

Correspondence Address: Muncy, Geissler, Olds & Lowe, PLLC, P.O. BOX 1364, FAIRFAX, VA, 22038-1364, US

(21) Appl. No.: 12/255,882

(22) Filed: Oct. 22, 2008

(51) Int. Cl. G01C 21/30; G01C 21/20; G01C 21/02

(52) U.S. Cl. 701/208; 701/207; 701/213

(57) ABSTRACT

An interactive positioning apparatus includes a positioning module, an interface module, an interactive information processing module, and an output module. The positioning module generates a positioning data. The interface module is coupled with the positioning module. The interactive information processing module, which is coupled with the interface module, generates interactive information. The output module, which is coupled with the interface module, outputs the positioning data and/or the interactive information. In addition, an interactive method of the interactive positioning apparatus is also disclosed.

### BACKGROUND OF THE INVENTION

1. Field of Invention

The present invention relates to an interactive positioning apparatus and an interactive method thereof.

2. Related Art

In recent years, since the electronic product manufacturing technology is progressing, the function of the products has been enhancing, and thus it is more common to use the positioning apparatus. Until this day, the positioning apparatus not only can combine together with the mobile phone for providing the position information to the user, and also can combine with the conveyance for providing the user the functions of navigation and positioning in view of an electronic map.

Some manufacturers provide a positioning apparatus with the tracking function for children, elders and patients. Such positioning apparatus may transmit the position of the user to a monitor end for obtaining the position of the user. However, since the positioning apparatus does not have other functions other than telling the positioning to the monitor end, the positioning apparatus has no apparent benefit and is an inconvenience for the user. Therefore the users would not voluntarily carry the positioning apparatus all the time, and the positioning apparatus will fail to reveal the actual position of the user to the monitor end.

For this, it is an important subject to provide an interactive positioning apparatus and its interactive method that can interact with the user so that the user is willing to carry it around, hence enhancing the whereabout accuracy of the intended user of the positioning apparatus.

### SUMMARY OF THE INVENTION

In view of the foregoing, the present invention is to provide an interactive positioning apparatus and its interactive method that can interact with a user so that the user is willing to carry the apparatus for a long time, and hence enhance the usefulness of the positioning apparatus.

To achieve the above, an interactive positioning apparatus of the present invention includes a positioning module, an interface module, an interactive information processing module and an output module. The positioning module generates the positioning information. The interface module is coupled with the positioning module. The interactive information processing module is coupled with the interface module and generates the interactive information. The output module is coupled with the interface module and outputs the positioning information and/or the interactive information.

To achieve the above, the present invention discloses an interactive method of an interactive positioning apparatus. The interactive positioning apparatus includes a positioning module, an interface module, an interactive information processing module, and an output module. The interactive method of the interactive positioning apparatus includes the steps of generating a positioning information from the positioning module, receiving an instruction from a user by the interactive information processing module, generating an interactive information by the interactive information processing module in accordance with the instruction and a default program, and outputting the interactive information or the positioning information by the output module.

As described above, the interactive positioning apparatus and its interactive method of the present invention are to generate the interactive information by adding in an interactive information processing module. Compared with the prior art, the present invention can interact with the user through the interactive information so that the interactive positioning apparatus can interact with the user. Thus, the user is willing to carry the interactive positioning apparatus for a long time, and the whereabout accuracy of the intended user of the interactive positioning apparatus can be increased.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic illustration of an interactive positioning apparatus according to a preferred embodiment of the present invention;

FIG. 2 is a schematic illustration of another interactive positioning apparatus according to the preferred embodiment of the present invention;

FIG. 3 is a flow chart of an interactive method of the interactive positioning apparatus according to the preferred embodiment of the present invention;

FIG. 4A is a schematic illustration of a tree structure program according to the preferred embodiment of the present invention;

FIG. 4B is a schematic illustration of the interactive information according to the preferred embodiment of the present invention; and

FIG. 4C is a schematic illustration showing a chart of weighted indices according to the preferred embodiment of the present invention.

### DETAILED DESCRIPTION OF THE INVENTION

The present invention will be apparent from the following detailed description, which proceeds with reference to the accompanying drawings, wherein the same references relate to the same elements.

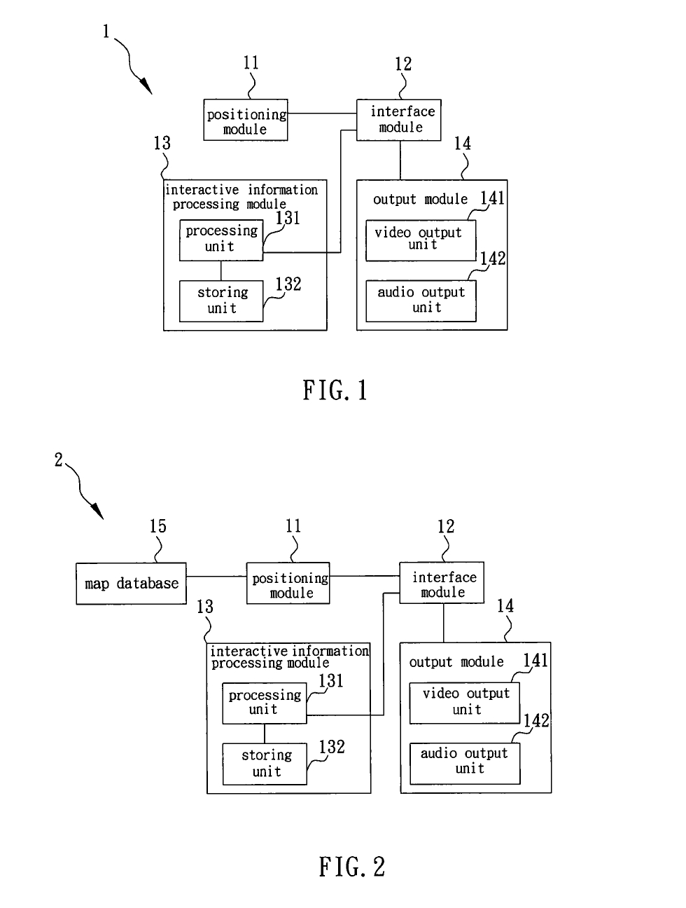

FIG. 1 is a schematic illustration of an interactive positioning apparatus 1 according to a preferred embodiment of the present invention. With reference to FIG. 1, the interactive positioning apparatus 1 has a positioning module 11, an interface module 12, an interactive information processing module 13, and an output module 14. In the embodiment, the interactive positioning apparatus 1 is a global positioning system (GPS) or a wireless communication device.

The positioning module 11 generates the positioning information in accordance with a GPS signal or a wireless signal. The wireless signal is transmitted by ground wave propagation, sky wave propagation, or line-of-sight propagation. In addition, the positioning information is, for example but not limited to, a coordinate information, a mobile speed information, a mobile positioning information, a navigation information, a landmark searching information, and their combinations.

The interface module 12 is coupled with the positioning module 11 and receives a trigger signal from an external terminal (not shown). The interface module 12 receives the trigger signal through the GSM, mobile communication technology, CDMA, personal handheld phone system (PHS), WLAN, or WiMAX. Naturally, in different applications, the interface module 12 may receive the trigger signal by the way of peer-to-peer (P2P), but not limited to this.

In the embodiment, the trigger signal is a text signal, a multimedia signal, a program code, or a coordinate signal. Additionally, the external terminal is a base station, a mobile phone, a computer system, or a positioning device.

The interactive information processing module 13 is coupled with the interface module 12 and generates the interactive information. In the embodiment, the interactive information processing module 13 includes a processing unit 131 and a storing unit 132. The processing unit 131 is coupled with the interface module 12; the storing unit 132 is coupled with the processing unit 131 and stores at least one default program. The processing unit 131 generates the interactive information in accordance with an instruction from a user and the default program. Moreover, the interactive information processing module 13 may generate the interactive information in accordance with the trigger signal received by the interface module 12.

In other words, the interactive information of the interactive positioning apparatus 1 can be generated by not only the instruction inputted by the user and the default program, but also the trigger signal inputted by an observer from the external terminal or the trigger signal transmitted by the external terminal itself. Hence the interactive positioning device 1 interacts with the user.

Furthermore, the default program may download the updated program files to enhance its function. The default program includes a tree structure program that is used with a weight indices chart so as to operate and execute the program. In the embodiment, the tree structure program may be a series of events.

The output module 14 is coupled with the interface module 12 and outputs the positioning information and/or the interactive information. The output module 14 includes a video outputting unit 141 and/or an audio outputting unit 142 to output the video information or the audio information.

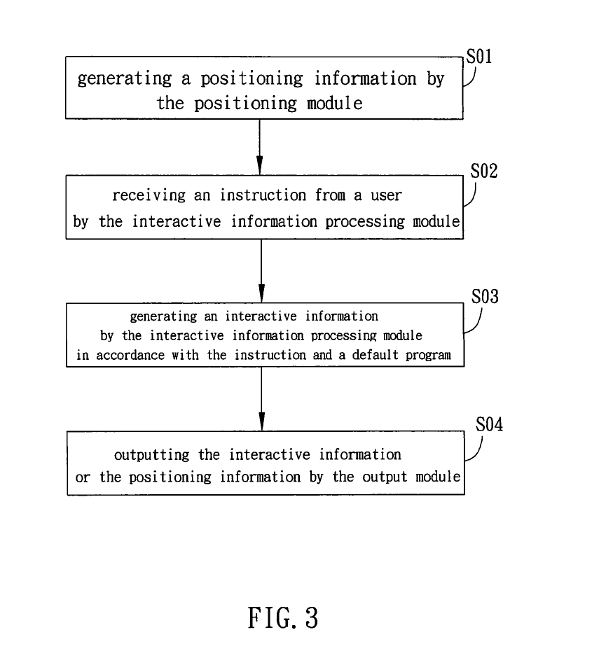

FIG. 2 is a schematic illustration of another interactive positioning apparatus according to the preferred embodiment of the present invention. With reference to FIG. 2, the difference between the interactive positioning apparatus 2 and the interactive positioning apparatus 1 is that the interactive positioning apparatus 2 further includes a map database 15. The map database 15 is coupled with the positioning module 11 for providing the information such as the mobile positioning information, the navigation information, or the landmark searching information to the user.

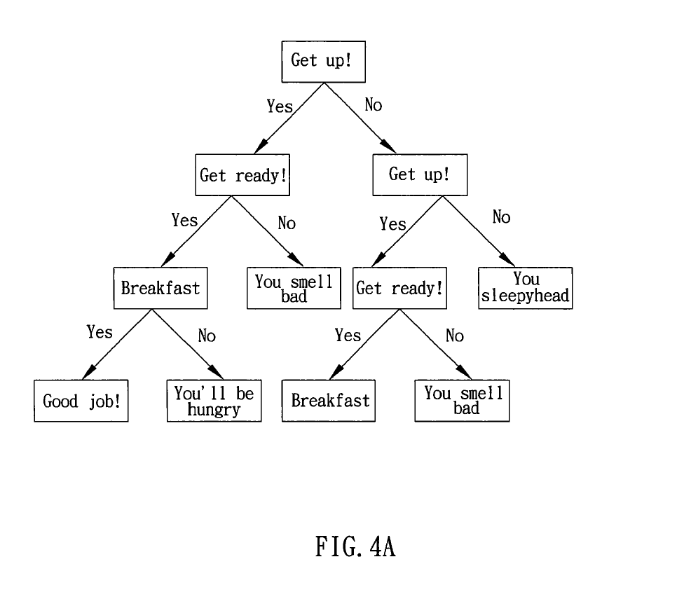

Hereinafter, an interactive method according to the preferred embodiment of the present invention will be illustrated with reference to FIG. 3 in view of FIG. 1. The interactive method may be implemented with the above interactive positioning apparatus 1. The interactive method of the positioning apparatus includes the steps S01 to S04.

Step S01 is to generate the positioning information by the positioning module 11. In the embodiment, the positioning information is generated in accordance with the GPS signal or a wireless signal.

Step S02 is to receive an instruction from a user by the interactive information processing module 13.

Step S03 is to generate the interactive information by the interactive information processing module 13 in accordance with the instruction and a default program. The default program includes a tree structure program that is used with a weight indices chart to operate and execute the program.

Step S04 is to output the interactive information or the positioning information by the output module 14.

Moreover, it is noted that the user inputs only one instruction in the embodiment for example. In practice, the user may orderly input more instructions to the interactive positioning apparatus in accordance with the interactive information.

Therefore, the interactive method of the interactive positioning apparatus further includes the steps, which are to receive another instruction from the user by the interactive information processing module and to change the interactive information (e.g. the video and audio information) in accordance with the default program. In other words, when the user keeps inputting the instructions, the steps S02 to S04 are repeated to change the outputted interactive information.

In addition, other than the steps of the above-mentioned interactive method that generate the interactive video and audio information through directly inputting the instruction by the user, the interactive method of the interactive positioning apparatus 1 of the present invention further includes a step, which is to receive a trigger signal from an external terminal by the interface module 12 to generate the interactive information. In the embodiment, the trigger signal may be a text signal, a multimedia signal, a program code signal, or a coordinate signal. Furthermore, the external terminal may be a base station, a mobile phone, a computer system, or a positioning device.

In practice, the interface module 12 receives the trigger signal through the GSM, mobile communication technology, CDMA, PHS, WLAN, or WiMAX.

Of course, the interactive method of the embodiment may be used with the interactive positioning apparatus 2 in FIG. 2. Since the interactive method of the interactive positioning apparatus 2 is the same as the above-mentioned interactive method, the detailed description thereof will be omitted.

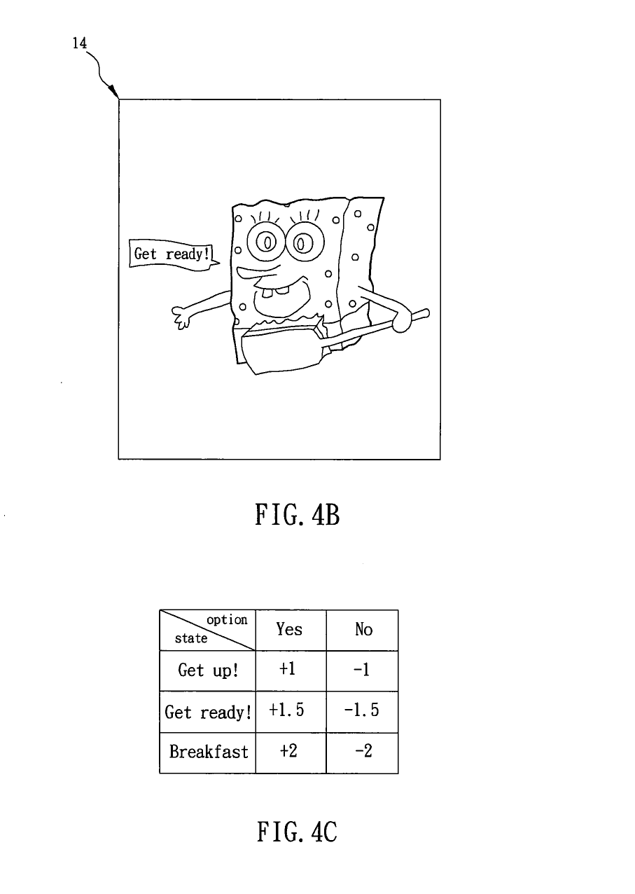

FIG. 4A is a schematic illustration of the tree structure program according to the preferred embodiment of the present invention. FIG. 4B is a schematic illustration of the interactive information according to the preferred embodiment of the present invention. FIG. 4C is a schematic illustration showing a chart of weight indices according to the preferred embodiment of the present invention. The tree structure is used with the weight indices chart. Referring to FIGS. 4A to 4C, the generating of the interactive information will be further illustrated as follow.

For a better illustration, the user is set to be a child and the default program is set to be a daily life event for example. When the interactive positioning apparatus 1 is activated at a preset time each morning, the input module 14 displays a virtual partner and shows a message “Get up!” at the same time. If the user chooses “Yes,” the input module 14 will output another message “Get ready!” and the virtual partner shows an action of getting up while the user inputs “Yes.” If the user chooses “No,” the input module 14 shows the message “Get up!” again after a predetermined time period, such as 5 minutes, to remind the user.

Similarly, as the message such as “Get ready!” is shown on the display and the user chooses “Yes,” as shown in FIG. 4B, the virtual partner shows the action of getting ready (brushing teeth and washing face). If the user inputs another option, the input module 14 generates different interactive information according to the tree structure program in FIG. 4A.

Moreover, the action of the virtual partner varies according to the interaction with the user. Referring to the weight indices chart in FIG. 4C that is used with the tree structure program in FIG. 4A, if the user chooses “Yes” when the message “Get up!” is displayed as shown in the above embodiment, the interaction between the virtual partner and the user obtains a weight value of “+1.” Similarly, if the user chooses “No,” the interaction between the virtual partner and the user obtains a weight value of “−1.” In practice, the action of the virtual partner varies with the interaction value. For example, the virtual partner provides extra options, information, or games for the increased interaction value and provides fewer hints or games for the decreased interaction value.

Additionally, it is noted that the default program may have a different configuration depending on the requests from the user and the monitoring terminal. Moreover, the interactive options between the user and the virtual partner are not limited to “Yes” and “No.”

According to the above-mentioned hardware structure and interactive method, the interactive information processing module 13 may generate different interactive information in accordance with the inputted instructions from the user, and by the interaction with the virtual partner, the willingness of the user to carry the positioning apparatus can be increased.

In addition, the interactive method of the present invention further generates the interactive information by the interactive information processing module in accordance with a trigger signal from the external terminal. The generating method of the interactive information is illustrated hereinafter.

In the embodiment, before the user uses the interactive positioning apparatus as described in the present invention, the group categorization to the specific external terminal is configured. For example, the family, friends, or colleagues are configured as different groups. To be noted, it is not necessary to perform the step of the configuration of group categorization.

When the user carries the above configured interactive positioning apparatus 1, if the interface module 12 receives the preset trigger signal outputted by the external terminal, the interactive information processing module 13 generates the interactive information in accordance with the trigger signal. The trigger signal in the embodiment is a coordinate signal. In other words, when the interface module 12 receives the coordinate signal showing the preset external terminal is within a predetermined range (e.g. 500 m) away from the interactive positioning apparatus 1, the output module 14 may output the interactive information from the audio output unit 142 to inform the user.

The user may interact with the external terminal according to the interactive information. Other than inputting the instruction by the user and communicating through the information such as audio and text information, the message (e.g. greeting) may also be transmitted to the external terminal automatically by the interactive apparatus 1 through the default program.

To sum up, the interactive positioning apparatus and its interactive method according to the present invention are to generate the interactive information by adding in the interactive information processing module. Compared with the prior art, the present invention may interact with the user through the interactive information so as to interact with the user. Hence the user is willing to carry the interactive positioning apparatus for a long time so as to enhance the usefulness and thus the practicability of the interactive positioning apparatus.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An interactive positioning apparatus, comprising:
a positioning module generating a positioning information;
an interface module coupled with the positioning module;
an interactive information processing module coupled with the interface module and generating an interactive information; and
an output module coupled with the interface module and outputting at least one of the positioning information and the interactive information.

2. The interactive positioning apparatus according to claim 1, wherein the interactive positioning apparatus is a global positioning system (GPS) device or a wireless communication device.

3. The interactive positioning apparatus according to claim 1, wherein the positioning information is generated in accordance with GPS information or a wireless signal.

4. The interactive positioning apparatus according to claim 1, wherein the interactive information processing module comprises:
a processing unit coupled with the interface module; and
a storage unit coupled with the processing unit and storing at least one default program.

5. The interactive positioning apparatus according to claim 4, wherein the processing unit generates the interactive information in accordance with an instruction from a user and the default program.

6. The interactive positioning apparatus according to claim 4, wherein the default program comprises a tree structure program.

7. The interactive positioning apparatus according to claim 1, wherein the interface module receives a trigger signal from an external terminal so that the interactive information processing module generates the interactive information in accordance with the trigger signal.

8. The interactive positioning apparatus according to claim 7, wherein the interface module receives the trigger signal through a GPS, a code division multiple access (CDMA), a mobile communication technology, a personal handheld phone system (PHS), a wireless local area network (WLAN), or a WiMAX.

9. The interactive positioning apparatus according to claim 7, wherein the trigger signal is a text signal, a multimedia signal, a program code, or a coordinate signal.

10. The interactive positioning apparatus according to claim 7, wherein the external terminal is a base station, a mobile phone, a computer system, or a positioning device.

11. The interactive positioning apparatus according to claim 1, wherein the output module comprises a video output unit and/or an audio output unit.

12. The interactive positioning apparatus according to claim 1, further comprising:
a map database coupled with the positioning module.

13. An interactive method of an interactive positioning apparatus, the interactive positioning apparatus comprising a positioning module, an interface module, an interactive information processing module, and an output module, the interactive method comprising the steps of:
generating a positioning information by the positioning module;
receiving an instruction from a user by the interactive information processing module;
generating an interactive information by the interactive information processing module in accordance with the instruction and a default program; and
outputting the interactive information or the positioning information by the output module.

14. The interactive method according to claim 13, further comprising the step of:
receiving another instruction from the user by the interactive information processing module so as to change the interactive information by the default program in accordance with the another instruction.

15. The interactive method according to claim 13, wherein the positioning information is generated in accordance with a GPS or a wireless signal.

16. The interactive method according to claim 13, further comprising the step of:
receiving a trigger signal from an external terminal by the interface module so that the interactive information processing module generates the interactive information in accordance with the trigger signal.

17. The interactive method according to claim 16, wherein the interface module receives the trigger signal through a GPS, a CDMA, a mobile communication technology, a PHS, a WLAN, or a WiMAX.

18. The interactive method according to claim 16, wherein the trigger signal is a text signal, a multimedia signal, a program code, or a coordinate signal.

19. The interactive method according to claim 16, wherein the external terminal is a base station, a mobile phone, a computer system, or a positioning device.

20. The interactive method according to claim 13, wherein the output module comprises a video output unit and/or an audio output unit.
